(19) United States
(12) Patent Application Publication
(10) Pub. No.: US 2020/0159040 A1
(43) Pub. Date: May 21, 2020

(54) METHOD AND APPARATUS FOR ENHANCING VR EXPERIENCES

(71) Applicant: Kiritz Productions LLC, VR Headset Stabilization Design and Nose Insert Series, Washington, DC (US)

(72) Inventors: Christina A. KIRITZ, Washington, DC (US); Abby D. LEVENBERG, Washington, DC (US)

(73) Assignee: Kiritz Productions LLC, VR Headset Stabilization Design and Nose Insert Series, Washington, DC (US)

(21) Appl. No.: 16/539,909

(22) Filed: Aug. 13, 2019

Related U.S. Application Data
(60) Provisional application No. 62/770,740, filed on Nov. 21, 2018.

(51) Int. Cl. G02C 5/12; G02C 9/00

(52) U.S. Cl. CPC G02C 5/126; G02C 9/00

(57) ABSTRACT

A method and apparatus for enhancing a VR experience for a user of a VR headset and HMD. The method includes increasing craniofacial contact of the VR headset and HMD to the user using a face conforming structure. The method also includes maintaining a sense of proprioception of the user via added support for the VR headset and HMD from the front of the user's face using the face conforming structure. The VR headset and HMD is stabilized to the face of the user in all directions using the face conforming structure by allowing the VR headset and HMD to rest on and deform or be supported by the face conforming structure.

### CROSS-REFERENCED TO RELATED APPLICATIONS

This application claims priority to and the benefit of U.S. Provisional Patent Application Ser. No. 62/770,740, filed on Nov. 21, 2018. The foregoing provisional application is incorporated by reference herein in its entirety.

### GENERAL DESCRIPTION

The present application relates generally to the field of headsets with head mounted displays (HMD), including to virtual/augmented/mixed reality/extended reality and peripheral attachments of the head mounted display.

Current virtual reality (VR), augmented reality (AR), and mixed reality (MR); Extended Reality (XR), (hereinafter jointly referred to as “VR”) users suffer greatly from so called “VR sickness” and/or dizziness which is motion sickness caused by the dilemma of the perceived moving horizon and lifelike sensations of the movement in the eyes juxtaposed with a more or less stationary inner ear. The sensory conflict or incongruent sensory inputs between the eyes and the inner ears throws off the sense of proprioception which maintains the feedback loop between the brain and one's body positions.

The application refers to VR headset and HMD throughout. The VR headset and HMD may be integrated into a single unit. Thus, the use of the terms VR headset and HMD in combination does not constitute a requirement for two separable structures or units. The VR headset and/or the HMD may be configured as a compact package or module such that only a single discrete unit or module is provided. Thus, as used in the application the term “VR headset and HMD” is intended to be directed to either two separate units or a single unit for providing the user with a VR experience.

Accordingly, an object of the present disclosure is to provide a face conforming structure that helps reduce motion sickness and extend time in which a VR headset and HMD may be comfortably used. The face conforming structure may include a nose piece.

The inventions disclosed herein include a method of reducing VR sickness of a user of a VR headset and HMD, the method comprising the steps of: increasing cranofacial contact of the VR headset and HMD to the user using a face conforming structure; maintaining a sense of proprioception of the user via added support for the VR headset and HMD from the front of the user's face using the face conforming structure; and stabilizing of the VR headset and HMD to the face of the user in all directions using the face conforming structure by allowing the VR headset and HMD to rest on and compress the face conforming structure.

### BRIEF DESCRIPTION OF THE DRAWINGS

The features, aspects, and advantages of the present invention will become apparent from the following description, and the accompanying exemplary embodiments shown in the drawings, which are briefly described below.

FIG. 1 is an isometric view of an exemplary nose piece.

FIG. 2 is a front view of the exemplary nose piece.

FIG. 3 is a side view of the exemplary nose piece.

FIG. 4 is a top view of the exemplary nose piece.

FIG. 5 is an isometric view of another embodiment of a nose piece.

FIG. 6 is a front view of another embodiment of the nose piece.

FIG. 7 is a side view of another embodiment of the nose piece.

FIG. 8 is a top view of another embodiment of the nose piece.

FIG. 9 is an exemplary face conforming structure configured as nose piece combined with a VR headset and HMD.

FIG. 10 is an isometric view of an exemplary nose piece with a fastening mechanism.

FIG. 11 is a rear side view of a VR headset and HMD with a face conforming structure.

FIG. 12 is an exploded rear side view of the VR headset and HMD with the face conforming structure removed.

FIG. 13 is an front side view of the face conforming structure.

FIG. 14 is an rear side view of the face conforming structure including a nose piece.

### DETAILED DESCRIPTION

Described herein is an invention for supporting from the front of the face, including from the nose, any headsets including a head mounted display (HMD), including, but not limited to VR headsets, VR glasses, VR goggles, VR screens, or other VR hardware worn on, or attached to, the head, and providing at least a visual indication of a VR environment such as phones mounted on a frame or other devices with a VR capable screen. A goal of the invention is to substantially reduce VR sickness by adding actual or imagined stability to maintain the body's sense of proprioception via added support for the VR headset and HMD from the front of the face, specifically the nasal bone, to stabilize the VR experience from all sides of the head including the front, top and back. The method and apparatus disclosed herein aids in reducing VR sickness in part by minimizing movement of the VR headset and HMD relative to the virtual environment, in part by providing tactile sensory feedback from the front of the face, and especially the nasal bone, cheeks and orbital bones, to help establish a spatial reference point of the head relative to the virtual environment, and in part by providing a visual reference to help establish a spatial reference point of the head relative to the virtual environment.

It has already been shown that adding a virtual “soft” nose within the virtual environment may minimize the VR sickness for some high intensity games. In one study, participants were able to engage with high movement games for longer periods without VR sickness when a “virtual nose” was embedded in the 3D environment. It is believed that the virtual nose helps the brain establish a sense of spatial location of the head relative to the VR scenery. In the real world, the nose is always visible, even though it is ignored unless consciously viewed. It is believed that the brain, in part, expects this constant reference, and without it, loses some sense of the location of the head and body relative to the environment. Without the virtual nose, the brain sees only a moving image, with no visual reference to the head. An embodiment of the invention disclosed herein furthers this concept by introducing additional physical support from the nose for the VR headset and HMD. For example, a face conforming structure may include a nose piece for a VR headset and HMD that provides support for the headset up from the nose with the purpose of reducing the intensity of VR sickness by stabilizing the VR experience of movement from the front of the face, and by linking the perception of movement to an actualized stationary source of weight.

In other embodiments, the face conforming structure may provide support to the VR headset and HMD from the user's orbital bone structure. The face conforming structure associated with the VR headset and HMD may be configured to match the orbital bones around the eyes. In additional to matching the user's orbital bone structure, as mentioned above, the face conforming structure may also be matched with the cheeks and/or nose structure of the user.

In one disclosed embodiment, the face conforming structure for a VR headset and HMD may be made from any suited material such as, but not limited to, silicone, rubber, foam, elastic, Velcro, conductive fabric and conductive thread and fabric or cloth of all types or any combination of such materials and may be be attached to the VR headset and HMD to lend support to the VR headset and HMD

In another embodiment the face conforming structure comprises a nose piece that may be clipped directed over the nose or strapped over the nose from the back of the head, made from any suitable material and is thick enough to hold up a VR headset and HMD such that the nose supports the VR headset and HMD via the nose piece.

In another embodiment, the face conforming structure is integrated into a VR headset and HMD to provide for support of the VR headset and HMD from the face nose, cheek and orbital bones as the face conforming structure is integrated into the frame of the VR headset and HMD.

In another embodiment, the face conforming structure may be attached to a VR headset and HMD and made from any suitable material such as, but not limited to, silicone, rubber, foam, elastic, Velcro, conductive fabric and conductive thread and fabric or cloth of all types or any combination of such materials in order to provide support to the VR headset and HMD via the face of the user.

In another embodiment the face conforming structure may be clipped directed over the face or strapped over the face from the back of the head, made from any suitable material such as, but not limited to, silicone, rubber, foam, elastic, Velcro, conductive fabric and conductive thread and fabric or cloth of all types. combination of such materials and is thick enough to hold up a VR headset and HMD such that the user's face supports the VR headset and HMD via the face conforming structure.

In another embodiment, the face conforming structure comprises a complete VR headset and HMD manufactured with support of the VR headset and HMD rom the face and face conforming structure integrated into the frame of the VR headset and HMD.

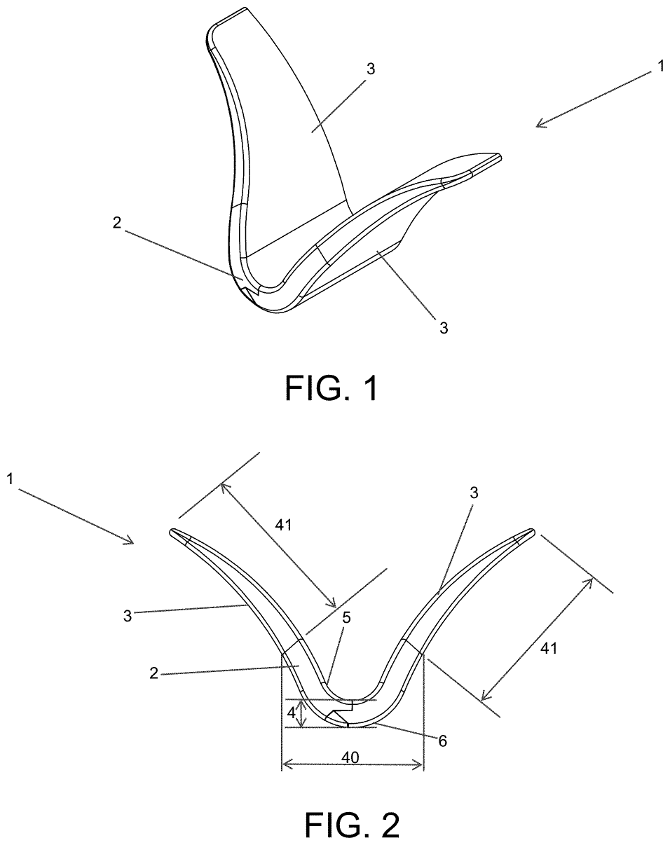

FIG. 1 illustrates an exemplary face conforming structure configured as a nose piece 1. In an exemplary embodiment, the nose piece 1 may comprise a silicone material inner body 2 made of out low density silicone foam. An outer body 3 may comprise a harder silicone foam. The three-layer mixed materials sandwich allows the nose piece to support the weight of the VR headset and HMD and keep the VR headset and HMD fixed while providing comfort, and stability to the user. Another embodiment of the nose piece 1 may include two layers of materials. An outer portion of the nose piece 1 may comprise of a harder silicone material in contact with the VR headset and HMD. An inner portion of the nose piece 1, in contact with the user's nose, comprise a softer silicone material for cushion and comfort for the VR headset and HMD user. Another embodiment of the nose piece 1 may include a single piece of low density of silicone foam. The low density silicone foam allows enough cushion and support for the VR headset and HMD. The nose pieces described in all embodiments may be casted via a mold. The different layers may be created by pouring the different layers at different times. The nose piece may be made from any suitable material such as, but not limited to, silicone, rubber, foam, elastic, Velcro, conductive fabric and conductive thread and fabric or cloth of all types or , rubber, foam, or any elastic material. The nose piece may be deformable, e.g., compressible, allowing the VR headset and HMD to be supported and cushioned by the nose piece 1. The nose piece 1 may deform to match the shape of the user's facial structure. The nose may further include hook and loop fasteners (Velcro), and may also include conductive fabric and conductive thread and cloth of all types. The conductive fabric or thread allows the user to further actuate objects such as lights or buttons through, enhancing the functionality and features of the VR headset and HMD.

FIG. 2 illustrates a front view of the exemplary nose piece. The shape of the nose piece 1 may be tailored to a specific user's face and nose contour. For example, the inner surface 6 may be contoured to match the surface of the user's nose. The material properties and dimensions of the nose piece may vary depending on the user. In one non-limiting example, the nose piece 1 may comprise of a maximum cross-sectional thickness 4 between 0.2″ and 0.6″. The maximum thickness lies on the symmetrical plane of the nose piece. The nose piece may also comprise a curvature ratio between 1.5 to 2.0. The curvature ratio is defined as the ratio of the radius of the curvature of the outer surface 5 to the radius of the inner surface 6 of the nose piece 1 about the location of maximum thickness 4.

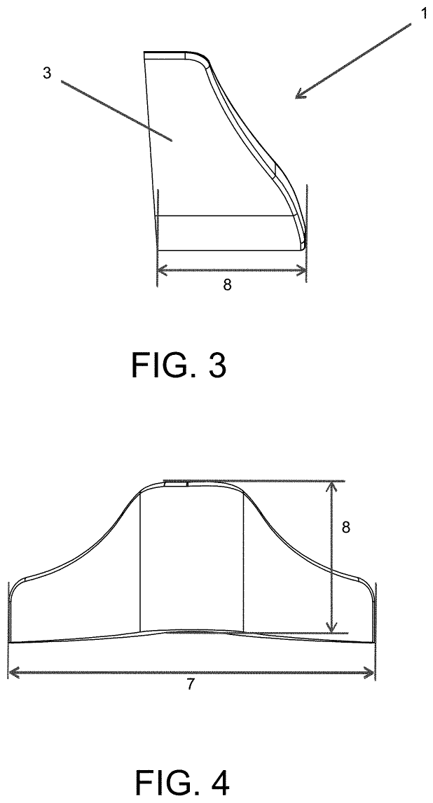

FIGS. 3 and 4 shows a side view and a top view of the nose piece respectively. An aspect ratio of the nose piece 1 may be about 2.5. The aspect ratio is defined as the end-to-end width 7 of the nose piece to the base length 8 of the nose piece 1.

The nose piece 1 may also include a harder bridge portion 40 and softer wing potions 41 (See FIG. 2). The bridge portion 40 is the middle portion of the nose piece 1, and is configured to rest on the bridge of the user's nose. The bridge portion may be made of a different material or processed differently such that the material is harder than the wing portions 41. The bridge portion may also gradually vary in hardness along base length 8 (see FIG. 3) such that the rightmost part of the nose piece (FIG. 3) is harder than the leftmost part of the nose piece. The gradient of the hardness may be tailored to the user's specific face and the VR headset and HMD that is being employed by the user.

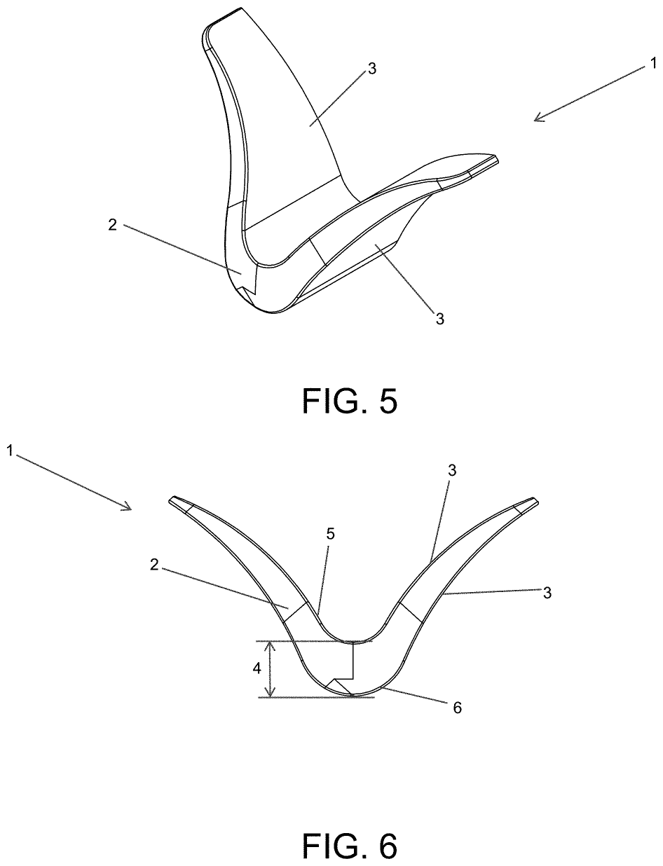

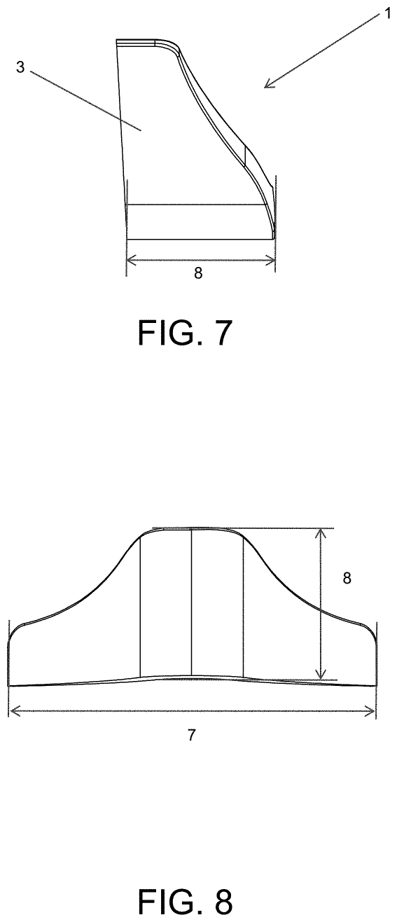

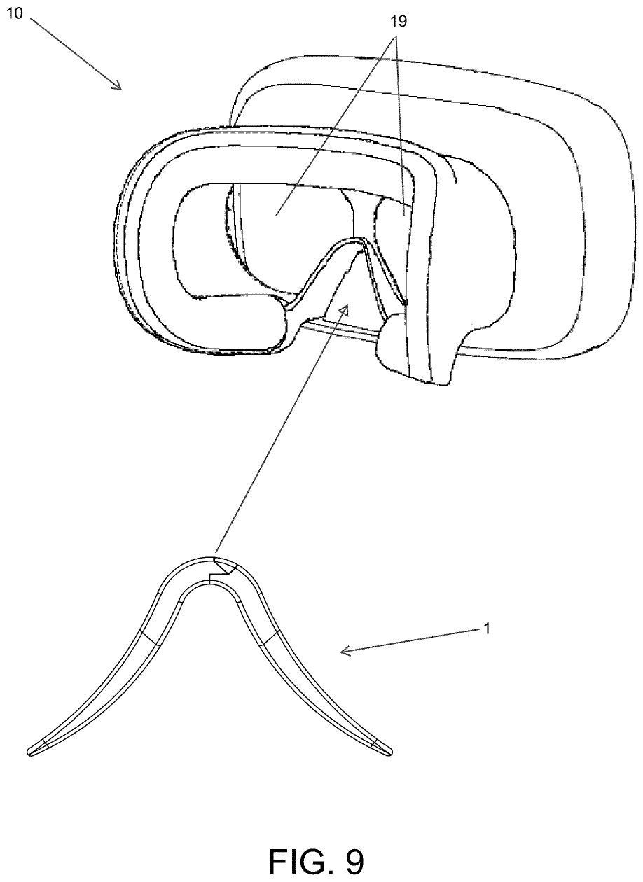

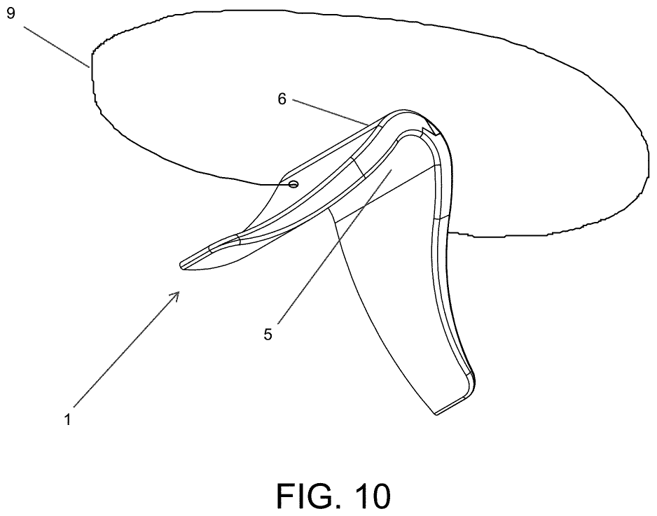

FIG. 5-8 show a different embodiment of a face conforming structure including a thicker nose piece 1. The thicker nose piece allows accommodation to a different nose and face profile. For example, a user with a smaller nose bridge may prefer the thicker nose piece 1 to allow better support of the VR headset and HMD to the user's nose.

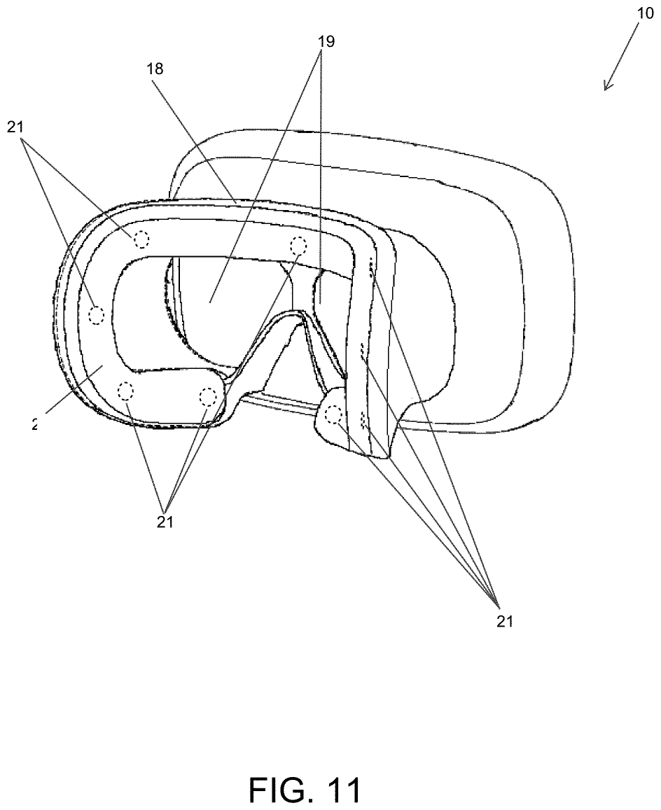

FIG. 9 shows an exemplary nose piece 1 and an exemplary VR headset and HMD 10 with a housing 18 and a head mounted display 19. The nose piece 1 may be selectively attachable to the VR headset and HMD 10 at the housing 18 and may be customized to the user's nose profile, allowing multiple users to comfortably use the VR headset and HMD. The nose piece 1 may also be integrated with the head mounted display 10 such that the housing 18 of the VR headset and HMD 10 may be unitary with the nose piece 1. The head mounted display may be manufactured with the nose piece shape. The head mounted display 19 may be of a mobile device such as a cellphone, or integrated displays within the VR headset and HMD 10.

FIG. 10 shows an exemplary nose piece 1 and a head fastening mechanism 9. In this embodiment, the nose piece 1 may be attached directly over the nose of the user and strapped to the head of the user via a strap 9. The strap may be integrated with the nose piece by having the strap run through the nose piece so that the strap is attached to the nose piece. The outer surface 6 of the nose piece 1 will conform to the housing 18 profile, and the inner surface 5 will conform to the user's nose. The shape of the nose piece 1 may be tailored to a specific user's face and nose contour for a better fit. Additional straps 9 may be added for more support. The strap 9 may also comprise other supports such as buckles or hook and loop fasteners such as, but not limited to “Velcro” to allow adjustment to the user's preference.

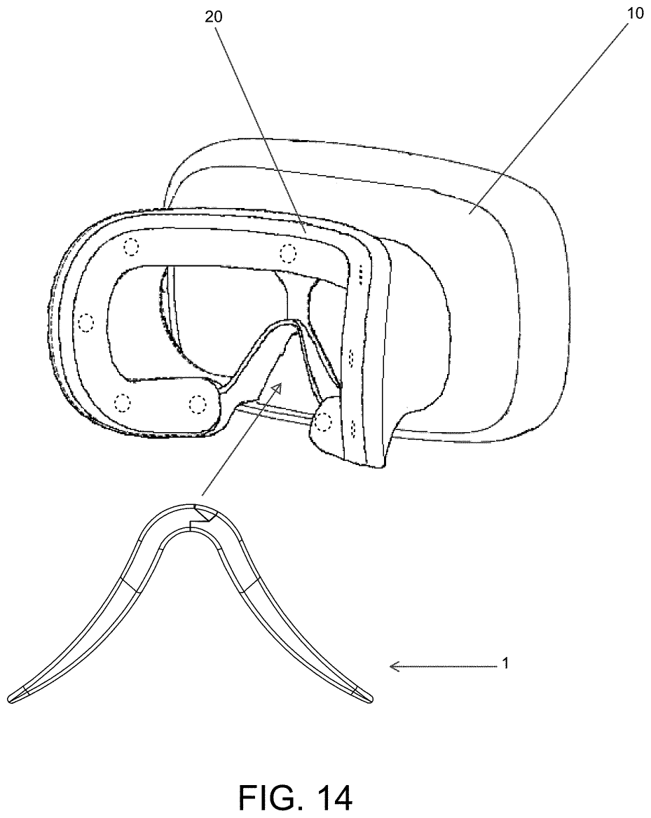

FIG. 11 shows an exemplary VR headset and HMD 10 with a face conforming structure 20 which is selectively attached to a VR headset and HMD housing 18. The face conforming structure described herein is suitable for use with any VR headsets and HMDs including those VR headsets and HMDs being developed for use with later generations of reality displays. For example, the face conforming structure may be used with, but not limited to, every version of commercially available headsets and HMDs now and in the future. The face conforming structure 20 may include a nose piece 1 as shown in FIG. 14. The face conforming structure 20 is contoured to match the surface of the user's face. The face conforming structure 20 may be selectively attached to the housing 18 to permit different users of the same VR headset and HMD 10 to have the advantage of the reduced VR sickness provided by the face conforming structure. For example, a different face conforming structure may be used based on the facial configuration, shape and structure of the use of the VR headset and HMD 10. In one example, the face conforming structure 20 may have a mask like surface on the face side of the face conforming structure. The face conforming structure may be made using additive manufacturing.

The shape of the face conforming structure including both the face conforming structure surrounding the eyes and/or the nose piece described above, may be developed based on a contour scan or image of the corresponding user's face. The contour scan allows three-dimensional topographical data of the user's face to be captured. The data may be used to create a face conforming structure that can be manufactured using any known manufacturing techniques, for example, additive manufacturing. The manufacturing process may either directly print the face confirming structure or print a mold of the face conforming structure, in which the mold can be injected with different materials to create the face confirming structure. Facial recognition software may also be used to derive the three-dimensional topographical data of the users face from an image. 3D printers and other printers, including, but not limited to laser printers and CNCs or future incarnations of these current printers and prototyping machines that may be used to create the face conforming structure 20, or create a mold so that the custom face conforming structure 20 may be casted. Other methods may be used to create the user's face conforming structure, for example a soft silicone based material may be applied to the user's face and removed to create the contour mold of the user's face. The mold is then used to cast the face conforming structure for the user. Other methods include facial recognition via Machine Learning and AI to determine the predominant differences in facial structures by clustering images to create composites of the main variations of facial structures that the user can match to best fit the user's face, which they can self-select based on the primary facial clusterings that most closely provide the “best fit” for more than one standard size, that most VR companies have yet to address. The clustering customization process is something that does not currently exist as of the time of this application.

The face conforming structure (including the nose piece) may be customized and personalized for a specific user using 3D scanner used to map facial recognition otherwise, as well as algorithms trained on customized annotated data to locate specific points of contact of the face conforming structure 20 specific to the intended user of the face conforming structure. Thus, a method may be employed where the user performs a facial scan at a first location and the facial scan data is transmitted or exported and imported into a variety of software programs that allow for 3D rendering of any kind of scan 3D or otherwise—including facial. These files can then be manipulated as needed and manufactured in different locations where there exists specialized custom face conforming expertise and access to appropriate software and hardware to render a physical manifestation of the invention/s.

The face conforming structure 20 may also be selected by a user from a ready-made inventory. The different sizes and shapes of the face conforming structure stored in the ready-made inventory may be developed to ensure that each available version of the face conforming structure functions to reduce the VR sickness and enhance VR experiences, directly addressing current issues that arise from use of existing VR headsets and HMDs.

The different sizes and shapes of the face conforming structure may also be created to clustering facial data to arrive at several different face configurations for face conforming structures. The facial data may be clustered based on the data so that users have similar facial features may select the same face conforming structure out of the available inventory. The clustering of the facial data may be accomplished, for example, by using algorithms and statistical analysis. The clustering may produce groups of facial structures having similar characteristics based on for example, ethnicity, genetics, gender norms, etc. Thus, a system may be employed that includes having a predetermined number of specialized (i.e., specific size and shape) face conforming structures 20 that may be produced and customized to fit these groups or clusters of facial structures. The nose piece may be one example of a face conforming structure that may be stored in an inventory of different sizes and shapes.

The face conforming structure 20 may be attached to the VR headset and HMD 10 via attachment mechanisms 21. The attachment mechanisms may include hook and loop fasteners (Velcro) or other means to attach the face conforming structure 20 to the housing 18 such as, for example, snap lock, clips, magnets or other suitable attaching mechanisms. The face conforming structure 20 may be made of silicone based or other suitable material.

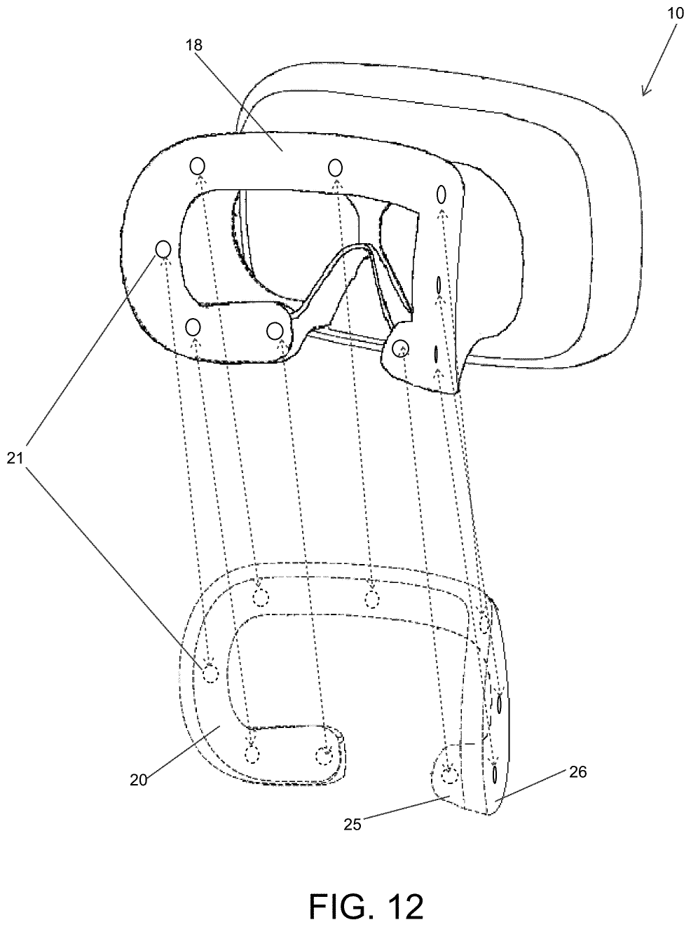

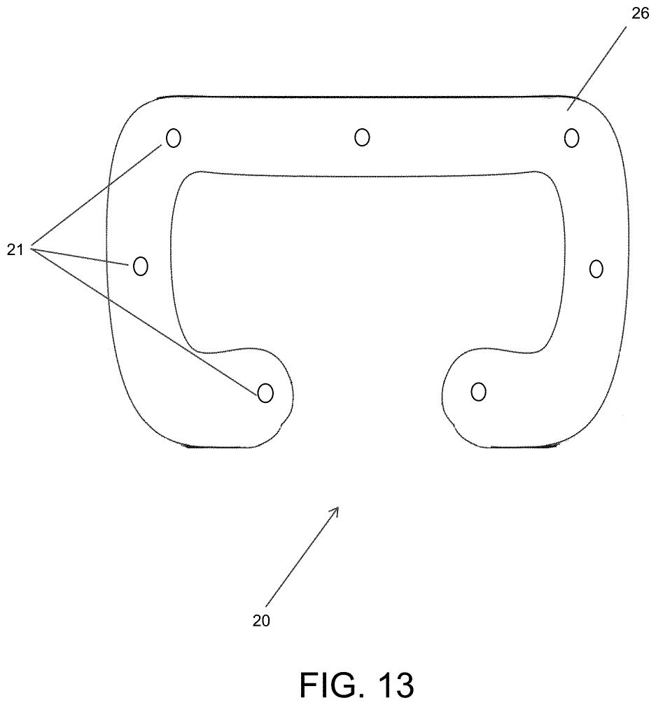

FIG. 12 shows an exploded view of the exemplary VR headset and HMD 10 with face conforming structure 20 and the housing 18. Attachment mechanisms 21 are decoupled and the face conforming structure 20 are be detached from the housing 18. The face conforming structure 20 comprises of a user side 25 and attachment side 26. The user side 25 will be customized and formed to the specific user's face contours such that the surface of the user side 25 of the face conforming structure 20 matches the surface of the user's face to provide a comfortable fit and allow an improved stability of the VR headset and HMD 10 to the user's face. The face conforming structure 20 also prevents leakage of external light into the VR headset and HMD 10, which would break the immersion of the VR experience. The matching face conforming structure may encompass the entire face of the user or only for region where the face would be enveloped by the head mounted display. The material employed on the face conforming structure is soft enough to provide comfort for the user while supporting the stability of the VR headset and HMD 10. The face conforming structure may be made from any suitable material such as, but not limited to, silicone, rubber, foam, elastic, Velcro, conductive fabric and conductive thread and fabric or cloth of all types. In another embodiment the face conforming structure 20 may be integrated to the housing 18 such that the face conforming structure is unitary and monolithic to the housing 18 to form a single part of the VR headset and HMD,

FIG. 13 shows the attachment side 26 of the exemplary face conforming structure 20. The attachment side 26 comprises of attachment mechanisms 21 that are coupled to the attachment mechanisms of the VR headset and HMD. The attachment mechanisms may include hook and loop fasteners, including Velcro or other means to attach the face conforming structure 20 to the housing 18 such as clips or magnets.

FIG. 14 shows another embodiment of the VR headset and HMD 10 and face conforming structure 20 with attachable nose piece 1. The attachable nose piece 1 may be attached via a mechanical means or magnetic means. The nose piece 1 may also be integrated to the face conforming structure 20 such that the face conforming structure 20 and nose piece 1 are unitary and monolithic such that the face conforming structure 20 and the nose piece 1 may be casted as a single piece.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

To the extent that the application discloses the connection of two or more structures, the term connection is not limiting. For example, such joining or connection is not limited to the embodiments disclosed herein. Such joining may be stationary (e.g., permanent) or moveable (e.g., removable or releasable). Such joining may be achieved with the two structures or the two structures and any additional intermediate structures being integrally formed as a single unitary body with one another or with the two structures or the two structures and any additional intermediate structures being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the VR headset and HMD is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A method of enhancing the experience of a user of a VR headset and HMD, the method comprising the steps of:
increasing cranofacial contact of the VR headset and HMD to the user using a face conforming structure customized to at least one facial structure;
maintaining a sense of proprioception of the user via added support for the VR headset and HMD from the front of the user's face using the face conforming structure; and
stabilizing the VR headset and HMD to the face of the user in all directions using the face conforming structure by allowing the VR headset and HMD to rest on and be supported by the face conforming structure.

2. The method of claim 1, wherein the face conforming structure comprises a nose piece, and wherein the nose piece comprises:
a supportable material shaped in a curved configuration to match the shape of a nose of a user of the VR headset and HMD; and
wherein the nosepiece is configured to be removably attached to the VR headset and HMD.

3. The method of claim 1, wherein the face conforming structure comprises:
a face side configured to be placed on the face of the user; and
an opposite facing attachment side configured to attach to a housing of the VR headset and HMD.

4. The method of claim 3, wherein the face conforming structure further comprises a nose piece having a supportable material shape in a curved configuration to match the shape of a nose of a user of the VR headset and HMD.

5. The method of claim 4, wherein the nose piece is removably attached to a portion of the face conforming structure surrounding the eyes of the user when the VR headset and HMD are/is being worn.

6. The method of claim 4, wherein the nose piece is monolithic and unitary to a portion of the face conforming structure surrounding the eyes of the user when the VR headset and HMD is being worn.

7. The method of claim 6, wherein the nose piece and the face conforming structure supports the VR headset and HMD from the cheekbones of the user.

8. The method of claim 1, wherein the face conforming structure is customized by clustering facial structure data into groups based on statistical analysis of the data, creating a plurality of face conforming structures, wherein each group comprises a plurality of facial structures, and wherein each of the plurality of face conforming structures correspond to one of the groups of clustered facial structure data sets.

9. The method of claim 1, wherein the face conforming structure is customized by obtaining facial structure data of a specific user generating the shape of the face conforming structure based on the facial structure data of the specific user.

10. A method of developing a face conforming structure configured to be attached to a VR headset and HMD, the method comprising the steps of:
customizing a contact surface of the face conforming structure to match the face of the user of the VR headset and HMD and wherein the contact surface is configured to contact the user when the VR headset and HMD is in use; and
further customizing an attachment surface of the insert to match the VR headset and HMD, wherein the attachment surface is configured to contact the VR headset and HMD.

11. The method of claim 4, wherein customizing a contact surface of the face conforming structure comprises:
collecting facial structure data;
clustering the facial structure data into facial groups using statistical analysis;
creating a group of face conforming structures, wherein each face conforming structure corresponds to one of the facial groups.

12. The method of claim 4, wherein customizing a contact surface of the face conforming structure comprises:
collecting facial structure using facial recognition scanners and algorithms to locate contact points on a face of the user
generating the face conforming structure contact surface based on the contact points of the face of the user.

13. A face conforming structure for a VR headset and HMD, the face conforming structure comprising:
a face side configured to be placed on a face of a user of the VR headset and HMD and an opposite facing attachment side configured to attach to a housing of the VR headset and HMD; and
wherein the face side of the face conforming structure is configured to match a surface of a face of the user.

14. The face conforming structure of claim 12, wherein attachment side of the face conforming structure comprises of at least one attachment mechanism configured to attach to a corresponding attachment mechanism of the VR headset and HMD.

15. The face conforming structure of claim 12, further comprising a nose piece having a supportive/supportable material shape in a curved configuration which can de/reform to match the shape of a nose of a user of the VR headset and HMD.

16. The face conforming structure of claim 14, wherein the face side of the face conforming structure is customized by clustering facial structure data into facial groups using statistical analysis.

17. The face conforming structure of claim 14, wherein the face side of the face conforming structure is customized by using facial structural data of the user to locate contact points on a face of the user and the shape of the contact surface is generated based on the contact points of the face of the user.

18. The face conforming structure of claim 14, wherein the nose piece is removeably attached to a portion of the face conforming structure surrounding the eyes of the user.

19. The face conforming structure of claim 14, wherein the nose piece further comprises a center bridge portion and outer wing portions surrounding the center bridge portion on opposite sides.

20. The face conforming structure of claim 18, wherein the center bridge portion is harder than the outer wing portions
